(19) United States
(12) Patent Application Publication
(10) Pub. No.: US 2025/0202163 A1
(43) Pub. Date: Jun. 19, 2025

(54) ELECTRICAL CONNECTION DEVICE WITH DEPLOYABLE ELECTRICAL PLUG

(71) Applicant: SANSO INVESTMENT SOLUTIONS, Paris (FR)

(72) Inventors: Antoine Lefaucheux, Grenoble (FR); Ronan Troufflard, Grenoble (FR)

(21) Appl. No.: 18/842,882

(22) PCT Filed: Feb. 27, 2023
(86) PCT No.: PCT/EP2023/054839

§ 371 Date: Aug. 30, 2024

(30) Foreign Application Priority Data
Mar. 3, 2022 (FR) FR2201860

(51) Int. Cl. H01R 13/635; H01R 13/447; H01R 13/62; H01R 13/639

(52) U.S. Cl. CPC H01R 13/635; H01R 13/447; H01R 13/6205; H01R 13/639; H01R 2201/26

(57) ABSTRACT

The invention relates to an electrical connection device comprising an electrical plug provided with electrical contact blocks, having a so-called front face and a so-called rear face, and a storage casing, the electrical plug being able to assume a retracted position in which it is housed in the storage casing and a deployed position in which it is at least partially outside of the storage casing, elastic return means being arranged between the rear face of the electrical plug and the storage casing, stressed mechanically by the electrical plug when the electrical plug is in its retracted position, and configured to eject the electrical plug from its retracted position to its deployed position.

### TECHNICAL FIELD OF THE INVENTION

The present invention relates to an electrical connection device with deployable electrical plug.

### STATE OF THE ART

Various solutions have already been proposed for recharging an electric vehicle. An electric vehicle is understood of course to mean a 100% electric vehicle or a vehicle of rechargeable hybrid type (for example electrical and internal combustion or electrical and hydrogen).

Some systems employed for recharging the vehicle use a magnetic effect to attract an electrical plug associated with the electric vehicle to an electrical socket linked to the network, and thus make an electrical connection when the plug and the socket are mechanically coupled by virtue of the magnetic effect. Such a solution is for example described in the patent EP3469662B1. In this solution, the plug is for example arranged in a storage unit assembled on the vehicle.

On the electrical plug side, a number of constraints emerge:
Maintaining the integrity of the plug against external aggressions, notably dust, impacts,
Ensuring constant operation over time, regardless of conditions, notably atmospheric (rain, snow, ice),
Being able to know the state of operation on the plug side.

The documents EP3680992A1, US2014/176071A1, EP2560245A1 and FR2973592 describe electrical sockets with retractable contacts.

The aim of the invention is to propose an electrical connection device suitable for managing one or more of the constraints cited above.

### SUMMARY OF THE INVENTION

This aim is achieved by an electrical connection device comprising an electrical plug (2) comprising a body and provided with electrical contact blocks housed in its body, the body of the electrical plug having a cylindrical form provided with several distinct radial apertures, each forming an access to a distinct electrical contact block, a so-called front face and a so-called rear face, the device comprising a storage casing, the electrical plug being able to assume a retracted position in which it is housed in the storage casing to prevent the access to its electrical contact blocks via said radial apertures and a deployed position in which it is at least partially outside the storage casing, the device comprising:
Locking means, arranged to assume a first, locking state for keeping the electrical plug inside the storage housing in its retracted position or a second, unlocking state, in which the plug is free to be moved from its retracted position to its deployed position,
Ejection means configured to eject the electrical plug from its retracted position to its deployed position when the locking means are in the unlocking state,
Means for controlling said locking means, configured to actuate said locking means between the locking state thereof and the unlocking state thereof.

According to one particular feature, the ejection means comprise elastic return means arranged between the rear face of the electrical plug and the storage housing, stressed mechanically by the electrical plug when the electrical plug is in its retracted position.

According to another particular feature, the elastic return means comprise at least one spring washer.

According to another particular feature, the plug comprises a magnetic architecture comprising a yoke and several permanent magnets, said magnetic architecture being assembled on said body.

According to another particular feature, the plug comprises a cover fixed to said body and covering the magnetic architecture, said cover forming the front face of said plug.

According to another particular feature, the locking means comprise several latches mounted to pivot on the storage casing of the plug, each latch in its locking state coming to bear against the front face of said plug to keep it in its retracted position against the elastic return means.

According to another particular feature, the device comprises a seal arranged between the plug and the storage casing.

According to another particular feature, the device comprises means for detecting the position of the plug with respect to a fixed assembly incorporating an electrical socket.

According to another particular feature, the detection means comprise one or more Hall effect sensors.

The invention relates also to an electrical connection system comprising an electrical socket, the system comprising an electrical connection device as defined above, in which the electrical plug can be connected to said socket.

### BRIEF DESCRIPTION OF THE FIGURES

Other features and advantages will emerge from the following detailed description given in light of the attached drawings in which:

FIG. 1 represents a complete electrical connection system including an electrical socket and an electrical connection device according to the invention, incorporating an electrical plug to be connected to the electrical socket;

FIG. 2 represents the electrical connection device according to the invention, seen assembled, and in which the electrical plug is in retracted position in the storage housing;

FIGS. 3A and 3B represent the electrical connection device according to the invention, seen exploded, respectively from the side and in perspective;

FIGS. 4A and 4B schematically illustrate the two positions assumed by the electrical plug with respect to its storage casing, respectively in retracted position in the casing and in deployed position outside the casing;

FIG. 5 illustrates an example of how the two magnetic architectures employed in the system can be realized.

### DETAILED DESCRIPTION OF AT LEAST ONE EMBODIMENT

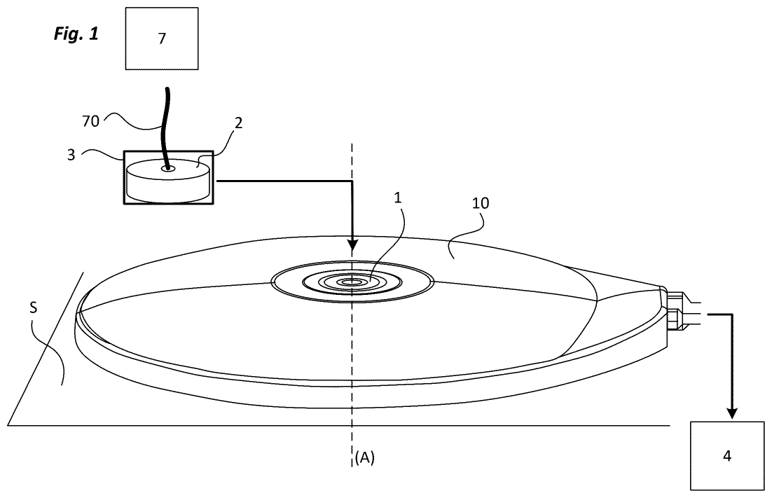

The invention targets an electrical connection device which is notably suited to be used in an electrical connection system employed for the recharging of a rechargeable electric or hybrid vehicle. In such a system such as that represented in FIG. 1, dedicated to the recharging of a rechargeable electric or hybrid vehicle, an electrical socket 1 is linked to the electrical network 4 and an electrical plug 2 is linked to the electrical power supply assembly 7 of the vehicle.

The system advantageously makes it possible to mechanically connect the plug 2 to the socket 1 automatically, without the intervention of an operative or of a robot, by using only magnetic and gravitational means, distributed on one side in the plug and on the other side in the socket.

For the rest of the description, a direction of connection is defined, corresponding to a main axis (A) along which the plug 2 is brought toward the socket 1 to be connected to the socket 1.

Hereinafter in the description, the terms “front” and “rear”, as well as “top” and “bottom” and “upper” and “lower” should be considered by taking account of the longitudinal position along the main axis (A).

Hereinafter in the description, the terms “internal” and “external” should be considered according to the coaxial position with respect to the main axis (A).

The device of the invention is for example intended to be employed on the vehicle side. It thus comprises the electrical plug 2 (hereinafter designated the plug). The plug 2 is connected to the end of a cable 70 and is set in motion by a mechanism so as to be connected to the electrical socket 1.

The electrical socket 1 can be incorporated in a fixed assembly as described in the patent EP3469662B1. FIG. 1 shows an exemplary embodiment of the system, in which the socket is incorporated in a plate 10, for example placed on the ground S.

In a nonlimiting manner, the mechanism for setting the plug 2 in motion can comprise a winder or a guideway system, associated with an electric motor, controlled to set the plug 2 in motion towards the electrical socket 1.

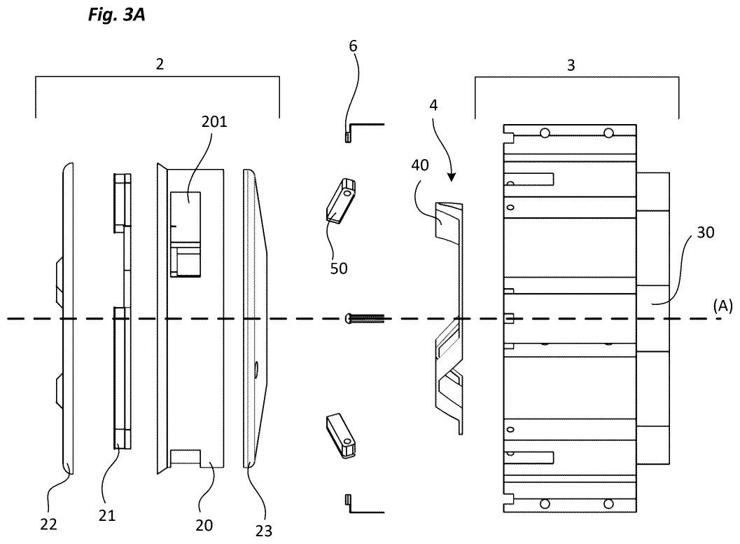

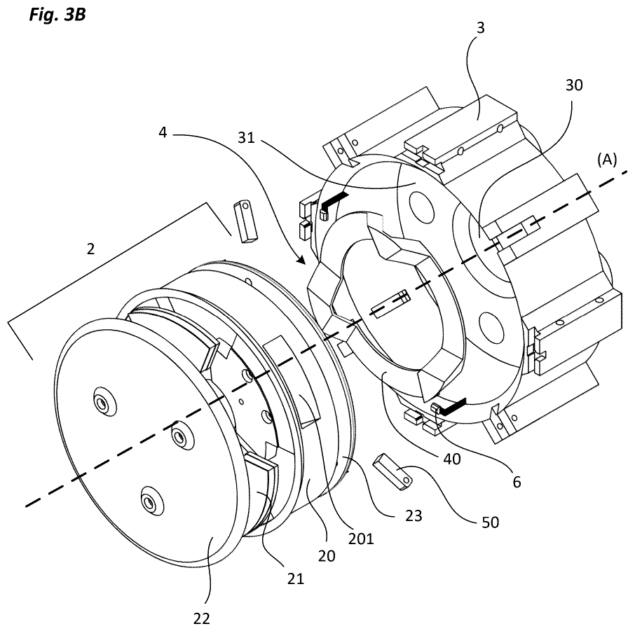

The device of the invention also comprises a storage casing 3 in which the plug 2 can be housed when it is not used. This casing 3 is used to protect the plug 2, notably its electrical contacts, from outside aggressions (dust, water, projectiles, etc.). The casing 3 for example takes the form of a bell developed around the main axis (A), pierced by an aperture 30 (FIG. 3A and FIG. 3B) at the rear to allow at least the electrical cable 70 to which the plug 2 is connected to pass through. The cable is free to slide through said aperture 30 when the plug 2 is set in motion. The storage casing 3 in bell form thus comprises a lateral wall and a bottom at the rear.

The storage casing 3 can be made of metal or plastic.

The cylindrical internal volume of the casing 3 advantageously has an internal diameter just greater than the outer diameter of the plug 2, such that the plug 2 can be embedded without friction in the casing 2, leaving a minimal and fitted annular gap.

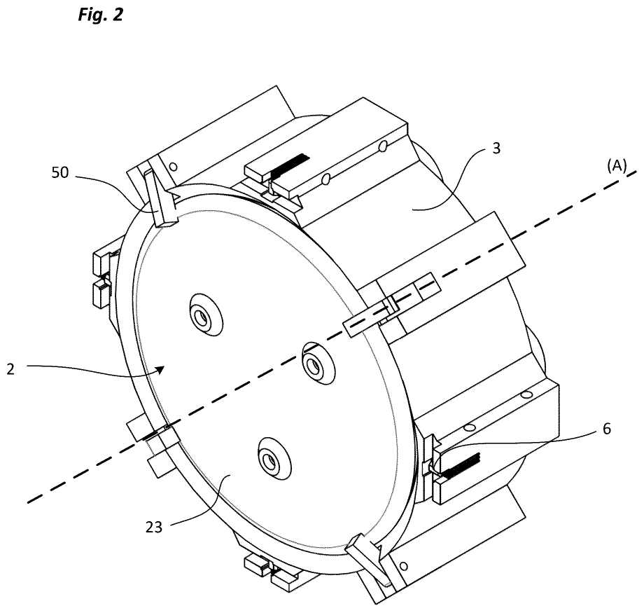

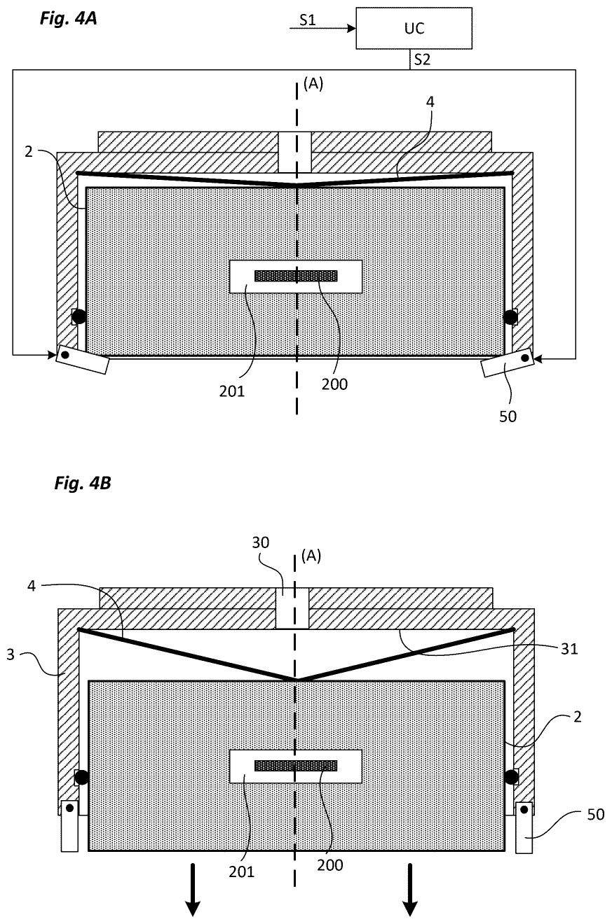

Referring to FIG. 2, FIG. 3A and FIG. 3B, the plug comprises a body 20, distinct from that forming the storage casing 3 (that is to say forming two structurally distinct assemblies), and several electrical contact blocks (200 schematically represented in FIG. 4A and FIG. 4B), incorporated in its body 20, each linked to one or more wires of the electrical cable 70.

This body 20 for example takes the form of a cylindrical part developed about the main axis (A), this part being for example made of plastic material.

The body of the plug 2 comprises a front face by which it can be mechanically stuck against the socket and an opposite rear face. This front face is deprived of any electrical contacts and closes the body of the plug on the side of its mechanical sticking plane against the socket 1.

The body 20 on the other hand comprises several radial apertures 201, each produced to give access to a distinct electrical contact block 200 present in the body of the plug. According to a particular embodiment, the plug 2 is thus advantageously configured to make electrical contacts with the socket 1 via several radial directions.

A seal 60 is advantageously placed between the body of the plug 2 and the storage casing 3, thus protecting the access to the radial apertures and therefore to the electrical contact blocks 200 of the plug 2.

The plug 2 also comprises a magnetic architecture 21, used to be mechanically coupled to the socket, provided with a complementary magnetic architecture.

The magnetic architecture is fixed to the front of the body 20 of the plug 2. The device can comprise a front cover 22 added onto the body 20 of the plug 2 to cover the magnetic architecture 21, the cover 22 forming the front face of the plug 2, by which it can be mechanically stuck against the front face of the socket.

The plug can also comprise a rear cover 23 fixed to the rear of its body 20, this rear cover 23 forming the rear face of the plug 2.

When the plug 2 is stuck by magnetic effect to the socket 1, an electrical connection is also made between the electrical contact blocks of the plug 2 and second electrical contact blocks of the socket 1, through the radial apertures 201 present on the plug 2.

The two magnetic architectures used make it possible to ensure that the plug 2 sticks to the socket 1 by magnetic effect. Different magnetic architectures allowing the plug 2 to be stuck to the socket 1 are notably described in the patent EP3317926B1 and in the patent application WO2020/229321A1. These are applicable to the present invention but should be considered as nonlimiting.

The two magnetic architectures advantageously comprise several permanent magnets. According to a particular feature, the two magnetic architectures operate by attraction when the plug is in a suitable angular position with respect to the socket to make the connection, or by repulsion when the plug 2 has to be removed from the socket 1 when being disconnected.

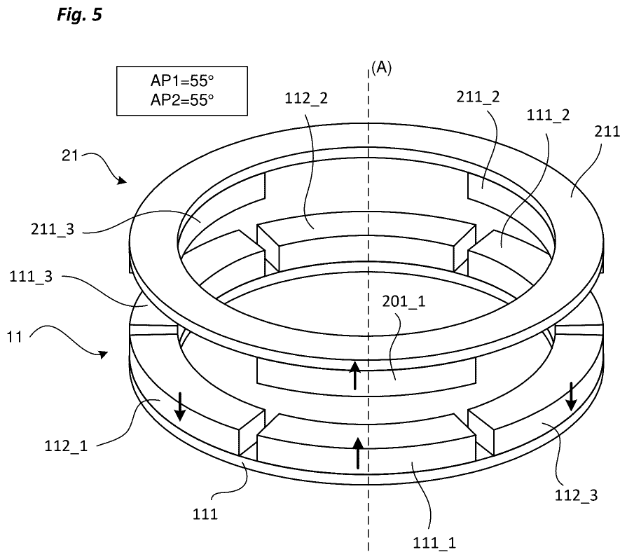

As an example, FIG. 5 shows a first magnetic architecture 11 present on the socket 1 side and a second magnetic architecture present on the plug 2 side. The two magnetic architectures represented comprise a ferromagnetic yoke 111, 211 and one or more permanent magnet portions fixed to said yoke.

On the first magnetic architecture 11, three permanent magnets 111_1, 111_2, 111_3 of a first set each extend over an angular range AP1 of 55° on their annular portion and three permanent magnets 112_1, 112_2, 112_3 of a second set extend over an angular range AP2 of 55°.

Each of the three new permanent magnets of the second set are inserted between two permanent magnets of the first set, leaving a non-zero regular angular gap with these two magnets of the first set. The regular angular gap 11 is close to 5° between two adjacent magnets.

The permanent magnets of the first set and those of the second set are magnetically oriented along the main axis (A) and in opposite directions.

The second magnetic architecture 21 has only a first set of three permanent magnets 211_1, 211_2, 211_3 which are identical to the permanent magnets of the first magnetic architecture.

It should be noted that the two magnetic architectures 11, 21 are configured to ensure that the plug 2 sticks against the socket, by magnetic attraction effect, according to a given orientation, about the main axis. The two magnetic architectures 11, 21 are configured such that the plug 2 can assume several distinct angular positions when it is stuck to the socket by magnetic effect.

For example, based on the magnetic architectures presented in FIG. 5, the plug 2 can assume three distinct angular positions, offset from one another by 120°. The plug can be in a first angular position, said to be at 0°, a second angular position said to be at −120° and in a third angular position said to be at +120°.

Obviously, the magnetic arrangements (angular ranges of the magnets and angular gaps between magnets) of the magnetic architecture can be adjusted.

According to a particular aspect of the invention, the device also comprises means for ejecting the plug 2 out of the storage casing 3. These ejection means advantageously comprise elastic return means 4, arranged between the rear face of the plug 2 and the bottom 31 of the bell forming the casing 3. These elastic return means 4 are fixed to the bottom of the bell. They are stressed by compression by the plug 2 when said plug is housed in the storage casing 2.

The device also comprises locking means arranged to assume a locking state in which they keep the plug 2 inside the storage casing 2, in a so-called retracted position. The locking means can switch to an unlocking state, freeing the plug 2, which can then assume a second, so-called deployed position. The plug 2 switches from its retracted position to its deployed position under the action of the elastic return means 4.

FIG. 4A shows the plug 2 in its retracted position. Its front face is situated inside the volume formed by the walls of the casing 3. It is kept in this position by virtue of the locking means, configured in their locking state. In this position, the plug 2 comes to bear against the elastic return means 4 arranged between its rear face and the bottom 31 of the bell. In this retracted position, the radial apertures 201 giving access to the electrical contact blocks 200 are not accessible, preventing any intrusion. The radial apertures are thus shut by the lateral wall of the storage casing 3.

A seal is advantageously arranged between the storage casing 3 and the plug 2, in a plane lower than that containing the radial apertures 201 of the plug 2, making it possible to ensure the seal-tightness of the internal volume of the body of the plug with respect to the outside when the latter is in its retracted position. This seal can be an O-ring seal 60 (shown in FIGS. 4A and 4B) for example placed in a groove produced on the internal lateral face of the storage casing 3 or stuck to this internal face. It makes it possible to ensure the seal-tightness between the plug 2 and the casing 3 and thus makes it possible to avoid the use of a lid or cap to enclose the plug 2 in the storage casing 3. It thus protects the access to the electrical contact blocks 200 present in the body of the plug 2 when the plug 2 is in its retracted position. Other sealing solutions could be envisaged.

FIG. 4B shows the plug in its deployed position. The locking means are in their unlocking state, freeing the movement of the plug 2, driven in translation toward the outside of the bell by virtue of the elastic return means 4. The plug 2 is thus ejected by the elastic return means 4 to exit from the internal volume of the bell. It should be noted that the ejection of the plug 2 is done prior to the connection to the socket. In other words, when the plug 2 is in the deployed position, outside the storage casing, it is not connected to the socket 1. The aim of this ejection principle is not to finalize the connection between the plug 2 and the socket 1. It simply makes it possible to free the plug from the position in which the access to its contact blocks is protected by the storage casing. The cable can have a little slack to allow the plug to be ejected from the casing. The connection is ended by unwinding the cable.

In a nonlimiting manner, the elastic return means can be formed by several helical springs and/or, advantageously, a spring washer 40 (as represented in the attached figures), for example a Belleville washer. Obviously, other solutions could be envisaged.

In a nonlimiting manner, the locking means can comprise several latches 50 mounted to pivot on the walls of the bell, each latch 50 being able to assume a raised position in which it is in the unlocking state (FIG. 4B) and a position folded back against the front face of the plug 2, in which it is in the locking state (FIG. 4A). The actuation of the locking means can for example be done electromagnetically or electrically.

The device comprises control means, configured to control the actuation of said locking means between their locking state and their unlocking state, or vice versa. These control means can comprise a processing and control unit UC (FIG. 4A) charged with executing an operating sequence.

Advantageously, the device can comprise detection means charged with following the position of the plug 2 with respect to the fixed assembly which bears the socket 1, to which the plug 2 is offered up to make the connection.

These detection means can comprise one or more sensors 6. In a nonlimiting manner, they can be Hall effect sensors arranged and distributed regularly on the perimeter of the bell, at its front rim.

Obviously, other types of sensors 6 could be employed, for example switches of “reed” or of MEMS or other such type.

As an example, the sequence of operation could be as follows:

### FIG. 4A:

The processing and control unit UC receives a connection request signal S1 from the plug 2 to the socket 1;
The processing and control unit UC can check that the plug 2 is indeed in its retracted position inside the casing 3;
The processing and control unit UC sends a command signal S2 to the locking means to order them to their unlocking state;
The locking of the plug 2 in position in the casing 3 makes it possible to relax the mechanical tension on the cable 70, a degree of slack being retained to allow the plug 2 to switch from its retracted position to its deployed position;

### FIG. 4B:

The locking means are actuated to their unlocking state, freeing the plug 2; the freeing of the plug 2 is made possible by virtue of the sufficient slack left by the cable 70 at the end of which the plug 2 is positioned;
Stressed by the elastic return means 4, the plug 2 is ejected to its deployed position;
The processing and control unit UC can control the means for setting the plug 2 in motion, for example the winder, to unwind the cable and bring the plug 2 in proximity to the socket for the connection;

The reverse sequence is implemented after the disconnection of the plug 2:
Reception by the processing and control unit UC of a signal indicating the disconnection of the plug 2 with respect to the socket 1;
The processing and control unit UC controls the means for setting the plug 2 in motion, to pull on the cable and lead it towards the inside of the storage casing 3;
The processing and control unit UC receives data originating from the detection means 6 and determines that the plug 2 is at least partially housed in the storage casing 3;
The processing and control unit UC sends a signal to the locking means to have them switch to their locking state, blocking the plug 2 in its retracted position. By being enclosed, the latches 50 press against the front face of the plug and thus compress the elastic return means 4;

The device of the invention offers many advantages, including:
A solution for ejecting the plug out of its casing, making it possible to notably eliminate all debris, ice, mud, likely to prevent its extraction from the casing;
A protection of the plug and of its contact blocks against external aggressions, by virtue of the storage casing; the solution notably makes it possible to dispense with the use of a cover or cap on the storage casing;
A simple manufacturing and assembly solution, offering the above-mentioned advantages.

1-9. (canceled)

10. An apparatus comprising an electrical connector, said electrical connector comprising a plug, a storage casing, a lock, an ejector, and a controller, wherein said plug is an electrical plug that comprises a body, a front face, a rear face, and electrical contact blocks housed in said body; wherein said body comprises a cylindrical body having distinct radial apertures, each of which provides access to a distinct electrical contact block; wherein said plug is configured to assume one of a retracted position and a deployed position; wherein, in said retracted position, said plug is housed in said storage casing to prevent access to said electrical contact blocks via said radial positions; wherein, in said deployed position, said plug is at least partially outside said storage casing; wherein said lock is arranged to transition between assuming a locked state and an unlocked state; wherein, when said lock is in said locked state, said lock keeps said plug inside said storage casing and in said retracted position; wherein, when said lock is in said unlocked state, said plug is free to be moved from said retracted position to said deployed position; wherein said ejector is configured to eject said plug from said retracted position to said deployed position when said lock is in said unlocked state; and wherein said controller controls said lock by causing said lock to transition between said locked state and said unlocked state.

11. The apparatus of claim 10, wherein said ejector comprises elastic arranged between said rear face and said casing and wherein said plug mechanically stresses said elastic when said electrical plug is in said retracted position thereof.

12. The apparatus of claim 10, wherein said ejector comprises a spring washer arranged between said rear face and said casing and wherein said electrical plug mechanically stresses said spring washer when said electrical plug is in said retracted position thereof.

13. The apparatus of claim 10, wherein said plug further comprises a magnetic architecture, wherein said magnetic architecture comprises a yoke and permanent magnets, and wherein said magnetic architecture is assembled on said body.

14. The apparatus of claim 10, wherein said plug comprises a magnetic architecture and a cover, wherein said cover covers said magnetic architecture, wherein said cover is fixed to said body, and wherein said cover forms said front face of said plug.

15. The apparatus of claim 10, wherein said lock comprises latches mounted so as to pivot on said casing, wherein each of said latches, when in a locking state thereof, bears against said front face of said plug, wherein each of said latches, when in said locking state thereof, keeps said plug in a retracted position against a force exerted by an elastic that is arranged between said rear face and said casing.

16. The apparatus of claim 10, further comprising a seal arranged between said plug and said storage casing.

17. The apparatus of claim 10, further comprising a position detector for detecting a position of said plug relative to a fixed assembly that incorporates an electrical socket.

18. The apparatus of claim 10, further comprising a Hall effect sensor configured to detect relative positions of said plug and a fixed assembly that incorporates an electrical socket.

19. The apparatus of claim 10, further comprising an electrical connection system comprising an electrical socket, wherein said plug is configured to connect to said electrical socket.
